(19) United States
(12) Patent Application Publication
(10) Pub. No.: US 2026/0072846 A1
(43) Pub. Date: Mar. 12, 2026

(54) SCALABLE HARDWARE CACHE WITH CONFIGURABLE LOGICAL PORTS AND RELATED THREAD MANAGEMENT

(71) Applicant: Microsoft Technology Licensing, LLC, Redmond, WA (US)

(72) Inventors: Suresh VEMULA, Tracy, CA (US); Narendra Jayawant GATHOO, San Jose, CA (US); Purval Shyam SULE, San Jose, CA (US); Wael NOUREDDINE, Los Altos, CA (US)

(21) Appl. No.: 18/826,461

(22) Filed: Sep. 6, 2024

(51) Int. Cl. G06F 12/0864; G06F 12/123

(52) U.S. Cl. CPC G06F 12/0864; G06F 12/123; G06F 2212/6032

(57) ABSTRACT

Systems and methods for a scalable hardware cache with configurable logical ports and related thread management are described. A scalable hardware cache includes a request interface having a first logical port and a second logical port associated with a fully-associative cache memory. The first logical port is configured to receive a first set of read requests with an expected cache hit and the second logical port is configured to receive a second set of read requests with an expected cache miss. The scalable hardware cache further includes thread processing circuitry to manage a first maximum number of a first set of threads for processing the first set of read requests and a second maximum number of a second set of threads for processing the second set of read requests that can be active at a given time based on a performance metric associated with the scalable hardware cache.

### BACKGROUND

Hardware accelerators often need to process a large amount of data when performing operations. While performing such operations, hardware accelerators often encounter performance bottlenecks due to the higher latency associated with accessing data stored in off-chip memories, such as double-data rate (DDR) memories or high-bandwidth memories (HBMs). While caching mechanisms have been used to help lower some of the latency associated with accessing the data in off-chip memories, traditional caching mechanisms do not adequately address the latency issues faced by hardware accelerators. Accordingly, there is a need for better caching systems and methods for addressing the latency issues.

### SUMMARY

In one example, the present disclosure relates to a scalable hardware cache including a fully-associative cache memory. The scalable hardware cache may further include a request interface having a first logical port and a second logical port associated with the fully-associative cache memory. The first logical port may be configured to receive a first set of read requests with an expected cache hit and the second logical port, different from the first logical port, may be configured to receive a second set of read requests with an expected cache miss.

The scalable hardware cache may further include thread processing circuitry configured to manage a first set of threads for processing the first set of read requests and a second set of threads for processing the second set of read requests, where each of a first maximum number of the first set of threads and a second maximum number of the second set of threads that can be active at a given time is selected based on a performance metric associated with the scalable hardware cache.

In another example, the present disclosure relates to a scalable hardware cache including a fully-associative cache memory. The scalable hardware cache may further include a request interface having a first logical port and a second logical port associated with the fully-associative cache memory, where the first logical port is configured to receive a first set of read requests with an expected cache hit and the second logical port, different from the first logical port, is configured to receive a second set of read requests with an expected cache miss.

The scalable hardware cache may further include thread processing scheduler circuitry configured to receive the first set of read requests and the second set of read requests and schedule the first set of read requests for processing using a first set of threads and schedule the second set of read requests for processing using a second set of threads. The scalable hardware cache may further include thread processing circuitry configured to, based on at least one latency metric associated with the hardware cache, select a first maximum number of the first set of threads for processing the first set of read requests and select a second maximum number of the second set of threads for processing the second set of read requests that can be active at a given time.

In yet another example, the present disclosure relates to a method for addressing latency issues with a hardware cache integrated within a hardware accelerator. The method may include configuring a fully-associative cache memory. The method may further include configuring a request interface having a first logical port and a second logical port associated with the fully-associative cache memory, where the first logical port is configured to receive a first set of read requests with an expected cache hit and the second logical port, different from the first logical port, is configured to receive a second set of read requests with an expected cache miss.

The method may further include based on at least one latency metric associated with the hardware cache, selecting a first maximum number of a first set of threads for processing the first set of read requests and selecting a second maximum number of a second set of threads for processing the second set of read requests that can be active at a given time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of an example system in which the hardware cache macro is implemented;

FIG. 2 is a block diagram of an example hardware cache macro (HCM);

FIG. 3 is a block diagram of a hash table for use with the example hardware cache macro of FIG. 2;

FIG. 4 shows the insertion of a new entry into the cache in accordance with one example;

FIGS. 5 and 6 show example cuckoo moves associated with the cache;

FIG. 7 is a block diagram of a computing system for addressing latency issues with a hardware cache integrated within a hardware accelerator; and

FIG. 8 shows a flow chart of an example method for addressing latency issues with a hardware cache integrated within a hardware accelerator.

### DETAILED DESCRIPTION

Examples described in this disclosure relate to caching systems and methods for addressing latency issues for hardware accelerators when accessing data. Certain examples further relate to a scalable hardware cache with configurable logical ports and related thread management. The hardware accelerators and the caching systems may be implemented as part of a standalone computing system or as a part (e.g., a server) of a public cloud, a private cloud, or a hybrid cloud. The public cloud includes a global network of servers that perform a variety of functions, including storing and managing data, running applications, and delivering content or services, such as streaming videos, electronic mail, office productivity software, or social media. The servers and other components may be located in data centers across the world. While the public cloud offers services to the public over the Internet, businesses may use private clouds or hybrid clouds. Both private and hybrid clouds also include a network of servers housed in data centers. Applications may be executed using compute and memory resources of the standalone computing system or a computing system in a data center.

Computing systems contain several types of memories, including caches. Caches help alleviate the long latency associated with access to main memories (e.g., double data rate (DDR) dynamic random access memory (DRAM)) by providing data with low latency. A hardware accelerator may have access to a cache hierarchy, including L1 caches, L2 caches, and L3 caches, where the L1 caches may be closest to the processing cores and the L3 caches may be the furthest. Data access may be made to the caches first and if the data is found in the cache, then it is viewed as a hit. If the data, however, is not found in the cache, then it is viewed as a miss, and the data will need to be loaded from the main memory (e.g., the DRAM). As explained earlier, hardware accelerators often need to process a large amount of data residing in memory when performing operations. While performing such operations, hardware accelerators often encounter performance bottlenecks due to the higher latency associated with accessing data stored in off-chip memories, such as double-data rate (DDR) memories or high-bandwidth memories (HBMs). While caching mechanisms have been used to help lower some of the latency associated with accessing the data in off-chip memories. Traditional caching mechanisms do not adequately address the latency issues faced by hardware accelerators. Accordingly, there is a need for better caching systems and methods for addressing the latency issues.

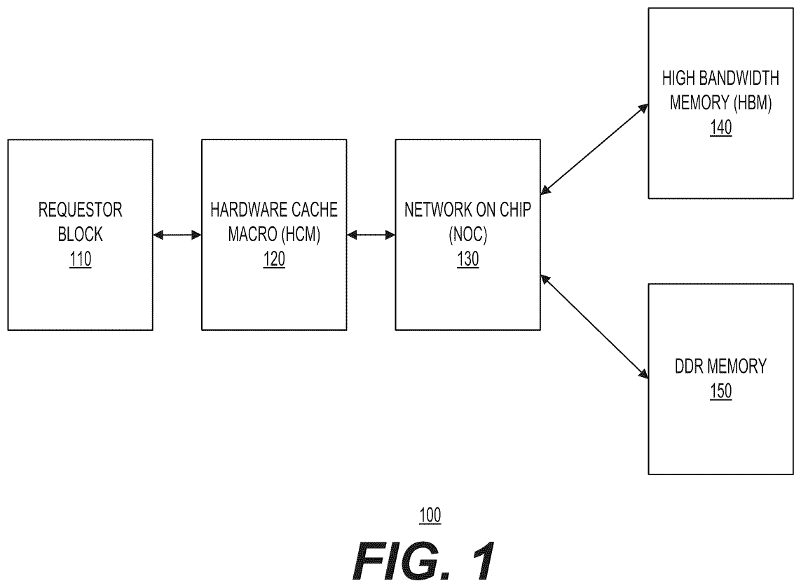

FIG. 1 is a block diagram of an example system 100 in which the hardware cache macro is implemented. System 100 includes a requestor block 110, a hardware cache macro (HCM) 120, a network on chip (NOC) 130, a high bandwidth memory (HBM) 140, and a DDR memory 150. Requestor block 110, HCM 120, and NOC 130 may be implemented as part of a hardware accelerator. Alternatively, these components may be included in any other chip, including a chip having a central processing unit (CPU), a graphics processing unit (GPU), an application specific integrated circuit (ASIC), a field programmable gate array (FPGA), or any other type of processing unit that can use HCM 120.

In one example, HCM 120 is implemented as a scalable hardware cache macro integrated within a hardware accelerator, serving as a high-speed buffer for the frequently accessed data. Additionally, in this example, HCM 120 employs a fully associative design, enabling any memory location to be stored in any cache line without the need for index calculations. Additionally, HCM 120 may utilize a true least recently used (LRU) replacement policy, ensuring optimal cache utilization and minimizing access latency. The modular design of HCM 120 allows for flexible deployment in diverse computing environments, thereby providing a scalable solution for optimizing memory access latency. Advantageously, HCM 120 provides low-latency access to off-chip memory (e.g., HBM 140 and DDR memory 150), reducing data retrieval times and improving overall system performance. Moreover, the fully associative cache architecture and the true LRU replacement policy maximize cache hit rates, minimizing the frequency of off-chip memory accesses. By mitigating latency and increasing cache efficiency, HCM 120 enhances the performance of the hardware accelerator blocks, enabling faster data processing and improved throughput. Although FIG. 1 shows system 100 with a certain number of components that are arranged in a certain way, system 100 may include additional or fewer components that are arranged differently.

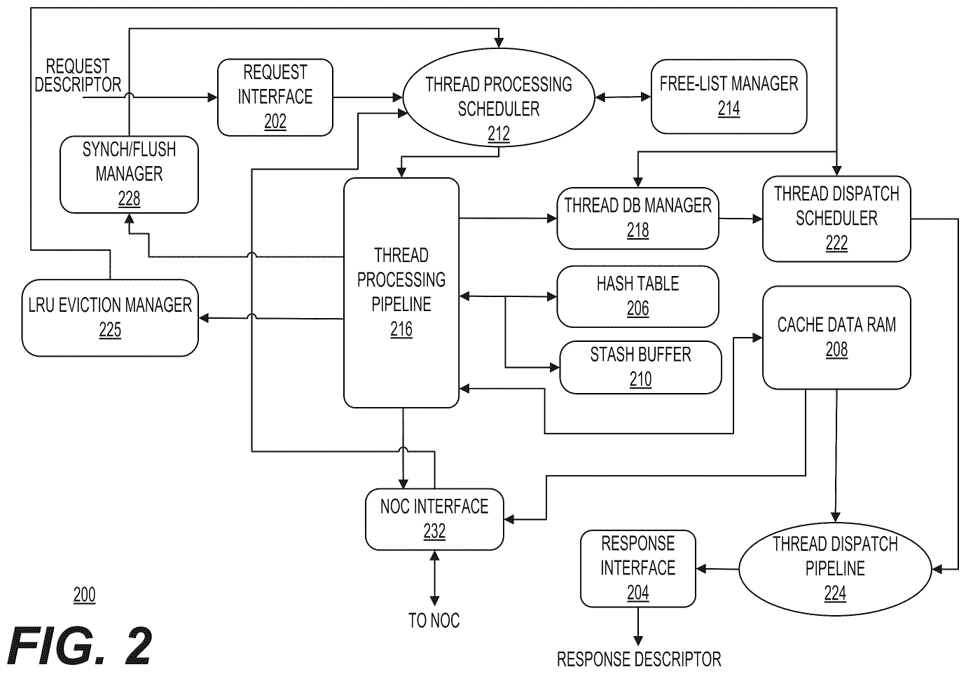

FIG. 2 is a block diagram of an example hardware cache macro (HCM) 200. In one example, HCM 200 corresponds to HCM 120 of FIG. 1. FIG. 2 shows the functional blocks for the HCM 200, which can be implemented using hardware logic, including state machines and other types of logic circuitry. In this example, HCM 200 includes a request interface 202 and a response interface 204. HCM 200 further includes a thread processing scheduler 212, a free-list manager 214, a thread processing pipeline 216, a thread database (DB) manager 218, a thread dispatch scheduler 222, and a thread dispatch pipeline 224. HCM 200 further includes an LRU eviction manager 225, a sync/flush manager 228, and an NOC interface 232. The data for the HCM 200 is stored in a cache data random access memory (RAM) 208. HCM 200 further includes a hash table 206 and a stash buffer 210. In one example, stash buffer 210 can be implemented as a content-addressable memory (CAM).

With continued reference to FIG. 2, the request interface 202 is configured to receive request descriptors from any requestor block seeking to access data stored as part of the cache. Response interface 204 is configured to provide response descriptors to the requestor block. Request interface 202 manages incoming requests, manages credits associated with the requester, and sends the requests to the thread processing scheduler 212. As explained further, the request interface 202 can support multiple logical ports with separate sets of credits for each of the logical ports and associated first-in first-out buffers (FIFOs). As an example, request interface can support four logical ports with separate sets of credits for each of the four logical ports and associated first-in first-out buffers (FIFOs). The FIFOs can be implemented as physical memory that holds all of the descriptors. The request interface 202 sends the requests to be scheduled for processing to the thread processing scheduler 212. Table 1 below shows an example request descriptor and table 2 below shows an example response descriptor.

TABLE 1

| | Example | |
|---|---|---|
| Example fields | width | Description |
| Command | 4 | Command Code |
| Sub-Command | 4 | Sub Command Bit-Vector |
| Logical Port ID | 2 | Logical Port Info (Read 0/Prefetch, Read |
| (2) | | 1, Debug/Init-Wr, Write) |
| Source | 10 | Source Tag Info (this value is returned |
| TAGInfo | | back with the response) |
| Key Value | 42 | Key value to be used for the Cache |
| | | Lookup. |
| Sub-Cacheline | n | If an entry has multiple cache lines, this |
| Pointer(n) | | pointer indicates which cache line is |
| | | being accessed. |
| Write Data | 512 | 64 B write data value |

TABLE 2

| | Example | |
|---|---|---|
| Example fields | width | Description |
| Logical Port | 2 | Logical Port Info (Read 0/Prefetch, Read |
| ID(2) | | 1, Debug/Init-Wr, Write) |
| Source | 10 | Source Tag Info (this value is returned |
| TAGInfo | | back with the response) |
| Read Data | 512 | 64 B write data value |
| CacheTagInfo | 32 | Dirty_bit, Cache Index, Hit_Status |

Although table 1 shows certain example fields and example widths, the request descriptor can include additional or fewer fields with different widths. Similarly, although table 2 shows certain example fields and example widths, the response descriptor can include additional or fewer fields with different widths.

HCM 200 is configurable and scalable since many of the parameters associated with HCM 200 can be configured as part of the logic design stage (e.g., by modifying the hardware description language (e.g., register transfer language (RTL) of the macro)) or via software registers at a later time. Example configurable parameters and example values for them are shown in table 3.

TABLE 3

| | Example | |
|---|---|---|
| Name | Values | Description |
| Key Width | 42-bit | Key Width is the width of the key value |
| | | associated with each of the cache entries. |
| | | This value is used for looking up the cache |
| | | entries. In one example, the key value is the |
| | | memory physical address. |
| Cache Depth | 4096 | Number of Cache Entries |
| Hash Table | 256 | Assuming 4 × 5 × 256 Hash Entries |
| Depth | | |
| Number of | 1 | Number of Cache lines/bucket (e.g., the lines |
| Cache | | share a common tag). |
| lines/Entry | | |
| Number of | 208 | Maximum number of active LP0 threads at any |
| LP0 Threads | | given time (Function of Memory Latency). |
| Number of | 16 | Maximum number of active LP1 threads at any |
| LP1 Threads | | given time (Function of Memory Latency). |
| Number of | 16 | Maximum number of active LP2 threads at any |
| LP2 Threads | | given time (Function of Memory Latency). |
| Number of | N/A | Reserved |
| LP3 Threads | | |
| Stash Buffer | 256 | Depth of the stash buffer (In one example, to |
| Depth | | avoid hash collisions, this depth may need to |
| | | be same as number of threads to avoid any |
| | | deadlock). |
| Data Width | 512 | Width of Read/Write Data bus |
| Number of | 1 | Number of FEP's that the Cache can spray |
| front end | | memory requests to. |
| processors | | |
| (FEP's) | | |

Although table 3 shows certain example parameters and corresponding example values for the HCM 200, other parameters and different values for the parameters may be used.

The thread processing scheduler 212 is configured to process the high priority requests before scheduling low priority requests in a round robin manner. The thread processing scheduler 212 can be configured to serve a request every other clock (or at a different serve frequency). In any case, having the thread processing scheduler 212 configured to serve a request every other clock allows for shallow FIFOs for the logical ports. Table 4 below shows example requests that thread processing scheduler 212 can be configured to schedule.

TABLE 4

| Request | | | |
|---|---|---|---|
| Type | Priority | Description | Type of Scheduling Required |
| Request- | High | This request can be | Scheduled as a high priority |
| LP2 | | used by all write | request for the respective |
| | | requests to the | logical port (e.g., LP2). |
| | | cache entry where | |
| | | a cache hit is | |
| | | expected. | |
| Request- | Medium | This request can be | All medium priority request |
| LP1 | | used by a read of a | queues can be grouped and |
| | | cache entry where | served in a round robin |
| | | a cache hit is | manner once all high priority |
| | | expected. | queues have been served. |
| Request- | Low | This request can be | All low priority request |
| LP0 | | used by a prefetch | queues can be grouped and |
| | | command or a first | served in a round robin |
| | | read of the cache | manner once the high priority |
| | | entry where a | and the medium priority |
| | | cache miss is | queues have been served. |
| | | expected. | |
| Read | Low | This is a read | |
| Response | | response from an | |
| | | external memory to | |
| | | the read request. | |
| Write | Low | Write | |
| ACK | | acknowledgement | |
| | | from the external | |
| | | memory. | |

Still referring to FIG. 2, free-list manager 214 manages the free pool of memory for the cache data RAM 208 and the thread database included as part of thread DB manager 218. In addition, free-list manager 214 provides reference pointers/tags as requested by the thread processing pipeline 216 and updates the free pool when the reference pointers/tags are released. Thread processing pipeline 216 orchestrates the functions performed by certain functional blocks shown as part of the HCM 200. Many operations for HCM 200 are performed under the control of the thread processing pipeline 216. These commands include read, write, and prefetch commands which are performed with respect to the logical ports. These commands further include additional commands that are performed with respect to the control and status registers (CSRs) included as part of HCM 200. Example commands supported by the thread processing pipeline 216 are shown in table 5 below.

TABLE 5

| | LP# | |
|---|---|---|
| Example | or | |
| commands | CSR | Description |
| Read | LP0, | Fetch the data into the cache from the external |
| | LP1 | memory. Return the data back to the source with |
| | | SourceTag based on the response policy. In one |
| | | example, the logical port LP0 can be used for |
| | | first cache read operation and logical port LP1 |
| | | can be used for subsequent reads. Logical port |
| | | LP2 can be used as a debug channel. |
| Write | LP2 | Write the data to the memory/cache entry. In one |
| | | example, the write operations are performed in the |
| | | order of arrival for processing. If there is a cache |
| | | miss, based on the sub command, perform a write |
| | | through operation or a write-allocate operation. |
| Prefetch | LP0 | Prefetch data into the cache from external memory. |
| Sync | CSR | Write back an entry in the Cache to the external |
| | | memory if present and dirty. |
| Query | CSR | Check if an entry is present in the cache, and |
| | | return the data from the cache. |
| Sync All | CSR | Write back all Dirty Cache entries to memory, |
| | | keep the entries in the cache. |
| Flush All | CSR | Write back all Dirty Cache entries to memory, |
| | | and then invalidate the entries in the cache. |

The thread DB manager 218 maintains the information about all active threads in a thread DB. The thread DB can be accessed using a thread tag or through a key value search. In this example, the thread DB manager 218 is configured to maintain all of the information that is required to process the threads. To further explain the information maintained as part of the thread DB by the thread DB manager 218, an example of the HCM 200 is described. This example assumes four logical ports (LP0, LP2, LP2, and LP3) and certain assumptions, which are shown in table 6 below.

TABLE 6

Memory Read Latency = 1 us
Memory Write ACK Latency = 250 ns
Performance Rate = 200 Mpps
Use LP0 the first read (Read 0).
Use LP1 for Read 1 (expected to hit the 2nd cache line) with
an expected Read Latency of 30 clocks.
Use LP2 for Write (expected to write 1 cache line) with an
expected Write Latency of 30 clocks.

Based on the above assumptions for an example of HCM 200, the thread DB with a total of 308 threads (208+16+4+16+64) can be split as shown in table 7 below.

TABLE 7
LP0: Read 0/Write (Alloc) (208 Thread Entries (200 + 8 for margin))
LP1: Read 1 (16 Thread Entries (16 * 6 = 96 clocks latency tolerance))
LP2: Write 1 (16 Thread Entries (16 * 6 = 96 clocks latency tolerance))
LP3 - Reserved (0 Thread Entries)
LRU Evict & Write Back Thread (64 Threads (64 * 6 = 384 clocks
for Write ACK latency tolerance))

Still referring to FIG. 2, in this example, the thread dispatch pipeline 224 is responsible for scheduling threads for processing or dispatch in a parameterized policy setting. Thread dispatch pipeline 224 can read the data from the cache and send it to the requester. Moreover, as part of a write back operation, the thread dispatch pipeline 224 can also receive the data via the NOC interface 232 from an external memory. In one example, the thread dispatch pipeline 224 is configured to first dispatch all response threads and only then dispatch all write back threads.

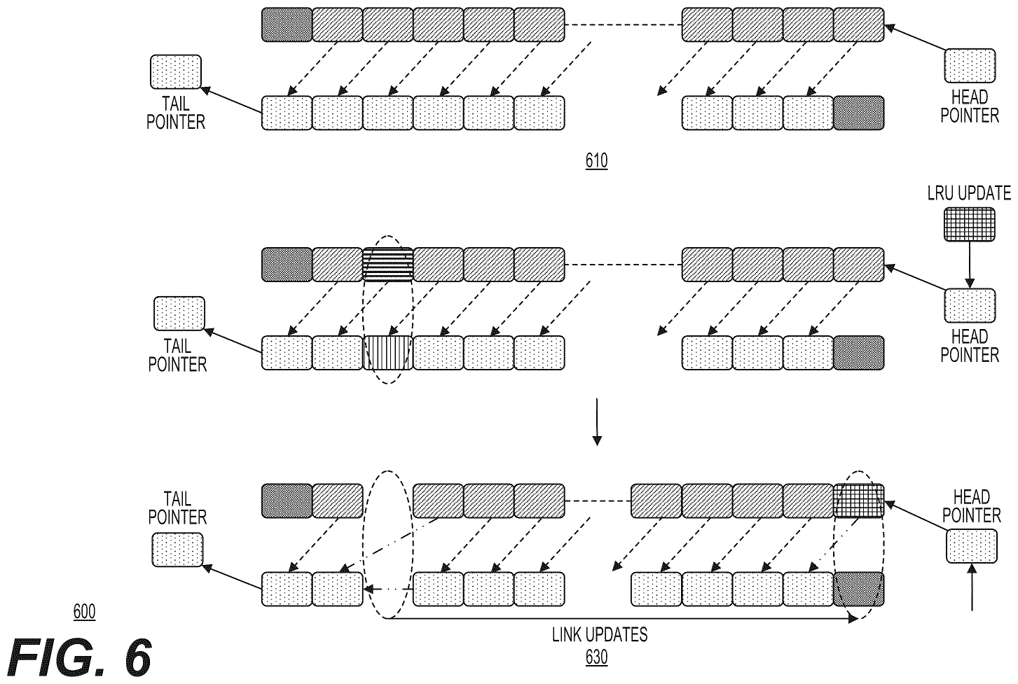

With continued reference to FIG. 2, the LRU eviction policy manager 226 implements a queue to cache entries in a doubly linked linked-list structure (additional details are provided with respect to FIG. 6). Each element in the linked list has both forward and backward reference to adjacent elements in the linked list. Every time a cache entry is accessed, it is removed from an arbitrary location in the queue and inserted at the head of the queue. Over a period of time the tail of the queue will hold the oldest entry in the queue. Once the cache entries reach a certain use threshold, the LRU eviction policy manager 226 may evict the oldest cache entries by reading from the tail of the queue and evicting the entries until the reference count drops below the set threshold, which can be set using software. The sync/flush manager 228 is responsible for performing full cache sync or flush operations. Such an operation can be initiated once all the open threads have been dispatched. Once the sync/flush operation starts, the new request processing is stalled until the sync/flush operation is complete.

Table 8 below describes the processing outlines associated with the various commands for hardware cache macro (e.g., HCM 200 of FIG. 2).

TABLE 8

| Example | |
|---|---|
| Commands | Processing outline |
| Cache | 1. If the Thread DB has at least one entry available, |
| Read | install and save the Request Info details. |
| | 2. Issue a Hash Look up command to hash table/stash |
| | buffer. |
| | 3. If there is a Hit with Entry Present, get the details |
| | of the cache entry and the cache state, and update the |
| | Thread DB with ready for dispatch. |
| | 4. Else If there is a Hit with Read Pending, get the |
| | details of the cache entry and the cache state, and |
| | update the Thread DB with ready for dispatch when |
| | cache fetch (from DDR) is complete. In one example, |
| | this Thread will be marked for dispatch when the |
| | corresponding response thread updates its status in |
| | the Thread DB. |
| | 5. Update the cache entry for sub-commands as |
| | required. |
| | 6. If the hash table is full, evict one of the oldest |
| | unlocked entry from the table and move the entry to |
| | the stash buffer. If the entry is unlocked, mark the |
| | entry for eviction and initiate the write back if |
| | the entry is dirty. |
| | 7. If the hash table way is not full, insert the new |
| | entry from the left. |
| | 8. If there is a cache miss, initiate a read from an |
| | external memory (cache fetch request), and update |
| | the cache entry. |
| Cache | 1. If the Thread DB has at least one entry available, |
| Write | install and save the Request Info details. |
| | 2. Issue a Hash Look up command to hash table/stash |
| | buffer. |
| | 3. If there is a Hit, get the details of the cache |
| | entry and the cache state, and update the cache data RAM. |
| | Update the cache entry for sub-commands, as |
| | required. |
| | 4. If there is a Miss, install an entry in the cache, |
| | update the data on the desired cache line, initiate |
| | a fetch, and mark the proper update flags on the |
| | entry when the read response is received. |
| | 5. If the cache is configured for more than a cache line, |
| | initiate a read for the other cache lines and when the |
| | response from the external memory is received, |
| | appropriately merge the cache entry correctly leaving |
| | modified dirty cache line unchanged. |
| | 6. If the hash table is full, evict one of the oldest |
| | unlocked entry from the table and move the entry to |
| | stash buffer. If the entry is unlocked, mark the entry |
| | for eviction and initiate the write back if the entry is |
| | dirty. |
| | 7. If the hash table way is not full, insert the new |
| | entry from the left. |
| Sync All | 1. Stop accepting new requests until the Sync All |
| | Command is processed. |
| | 2. Make sure all the pending threads are complete and |
| | dispatched. |
| | 3. Once the LRU manager receives a Sync All/Flush All |
| | command, maintain a count of the number of dirty |
| | entries in the cache, and if required also maintain a |
| | count of the number of dirty cache lines. |
| | 4. Initiate a sequential read of hash table entries and a |
| | walk through all cache info descriptors. If a dirty |
| | entry/cache line is found, initiate a write back |
| | operation. |
| Flush All | 1. Stop accepting new requests until the Flush All |
| | Command is processed. |
| | 2. Make sure all of the pending threads are complete |
| | and dispatched. |
| | 3. Maintain a count of the number of dirty entries in the |
| | cache, and if required also maintain a count of the |
| | number of dirty cache lines. |
| | 4. Initiate a sequential read of hash table entries and a |
| | walk through all cache info descriptors. If a dirty |
| | entry/cache line is found, initiate a write back |
| | operation. |
| | 5. Once the dirty entry is written, mark the entry as |
| | invalid, evict the entry from the hash table, and |
| | release the cache reference to the free pool. |
| | 6. If the entry is not dirty, mark the entry as invalid, |
| | evict the entry from the hash table, and release the |
| | cache reference to the free pool. |
| Sync | 1. If the Thread DB has at least one entry available, |
| | install and save the Request Info details. |
| | 2. Issue a Hash Look up command to Hash Table/Stash |
| | Buffer. |
| | 3. If there is a Hit, get the details of cache entry |
| | and the cache state. |
| | 4. Once write ACK(s) from the external memory are |
| | received, update the Thread DB |
| | 5. If multiple writes are required, issue them |
| | sequentially, looping via the Thread DB by initiating |
| | one write per command processing pipeline. |
| | 6. One all of the Write ACKs are received, mark the |
| | thread for Dispatch. |
| | 7. If there is a Miss, mark the thread as done and ready |
| | for dispatch. |
| Flush | 1. If the Thread DB has at least one entry available, |
| | install and save the Request Info details. |
| | 2. Issue a Hash Look up command to hash table/stash |
| | buffer. |
| | 3. If there is a Hit, get the details of cache entry |
| | and the cache state |
| | 4. If the cache entry is dirty, initiate writes to |
| | the external memory, update the Thread DB. |
| | 5. Once the write ACK(s) are received, update the |
| | Thread DB |
| | 6. If multiple writes are required, issue them |
| | sequentially, looping via the Thread DB by initiating |
| | one write per command processing pipeline. |
| | 7. Once all of the Write ACKs are received, mark the |
| | thread for Dispatch. |
| | 8. Evict the Entry in the Hash table, release the entry |
| | to free pool. |
| | 9. If there is a Miss, mark the thread as done and ready |
| | for dispatch. |
| NOP | 1. If the Thread DB has at least one entry available, |
| | install and save the Request Info details. |
| | 2. Issue a Hash Look up command to the hash |
| | table/stash buffer. |
| | 3. If there is a hit, process the desired sub-command |
| | and update the Thread DB for completion. |
| | 4. If there is a miss, update the Thread DB for |
| | completion. |
| Cuckoo | 1. Initiate a cuckoo move that is equivalent to an Insert |
| Move | (Read) operation with NOP by searching in the hash |
| | table. |
| | 2. If empty slots are found in the hash table, use D-Left |
| | to insert the entry from the stash buffer to the hash |
| | table and delete the entry from the Stash buffer. |
| | 3. If the hash table is full, randomly evict an entry |
| | from the hash table to make place for Cuckoo-move entry |
| | and place the evicted entry in the stash buffer to |
| | attempt the cuckoo move again. |
| Thread | 1. Thread dispatch involves a Cache data RAM read if it |
| Dispatch | is a Read Request. |
| | 2. Form the Response descriptor and send it out. |
| | 3. Delete the entry from the Thread DB and release the |
| | reference to the free pool. |
| Read | 1. Using the thread tag in the read request, locate the |
| Response | Thread DB entry. |
| | 2. Extract the Request details, perform the hash look up |
| | again to locate the Cache entry. |
| | 3. Update the Cache data RAM with the received cache |
| | line. |
| | 4. Update the Cache Tag info. |
| | 5. Once the read operation for one or both cache lines |
| | is complete, update the original thread as ready for |
| | dispatch. |
| | 6. Initiate a look up on the Thread DB to check if more |
| | than one thread is trying to read the same cache line. |
| Thread DB | 1. Perform the lookup on the Thread DB to check if |
| Read | more than one thread is trying to read the cache line |
| Complete | that has been fetched by an earlier thread. |
| Lookup | 2. Update the thread as ready for dispatch. |
| | 3. Initiate a look up on the Thread DB to check if more |
| | than one thread is trying to read the same cache line. |
| | 4. If there is a miss in the Thread DB, NOP the |
| | operation. |
| Write ACK | 1. Using the thread tag in the read request, locate the |
| | Thread DB entry. |
| | 2. Update the Thread DB as write complete. |
| | 3. If the Entry is marked for eviction, evict the |
| | entry from the stash buffer and release the reference |
| | pointers to the free pool. |
| Cache | 1. If the Prefetch Thread DB has at least one entry |
| Prefetch | available, install and save the Request Info details. |
| | 2. Issue a Hash Look up command to the hash |
| | table/stash buffer. |
| | 3. If there is a Hit, get the details of cache entry and |
| | mark the thread as done and free the thread entry. |
| | 4. If the hash table is full, evict one of the oldest |
| | unlocked entry from the table and move the entry to |
| | stash buffer. If the entry is unlocked, mark the entry |
| | for eviction and initiate the write back if the entry is |
| | dirty. |
| | 5. If the hash table way is not full, insert the new |
| | entry from the left. |
| | 6. If there is a miss, initiate a read (cache |
| | fetch request) and update the cache entry. |
| | 7. Once the response is received, update the entry, |
| | mark the thread as done and free the thread entry. |

Although table 8 above shows a certain number of commands associated with the hardware cache (e.g., HCM 200 of FIG. 2), the hardware cache can be configured to process additional or fewer commands. Moreover, the steps described as part of the processing outline for each of the commands can be modified, as needed.

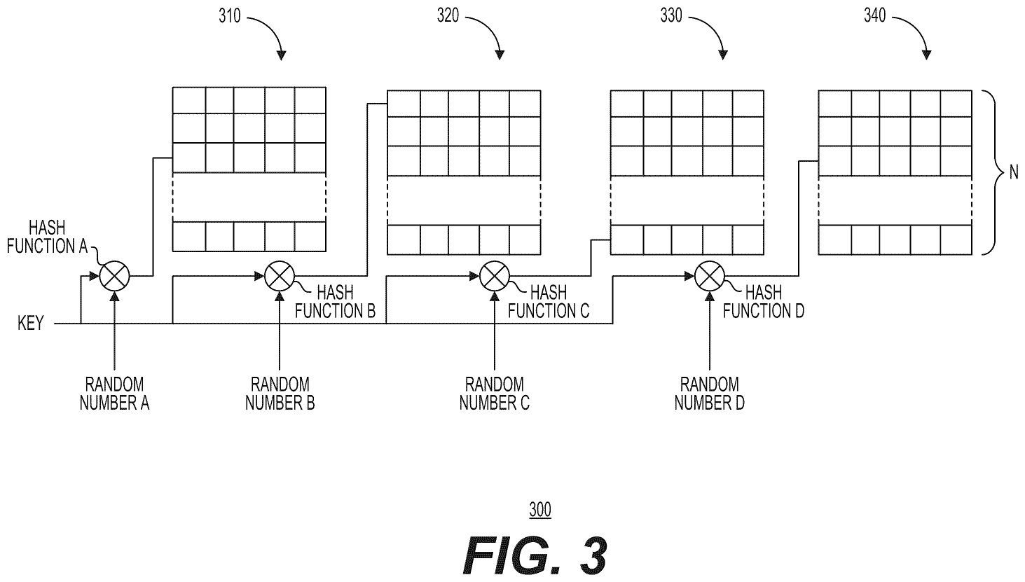

FIG. 3 is a block diagram of a hash table 300 for use with the example HCM 200 of FIG. 2. As an example, hash table 300 can be used to implement the hash table 206 for HCM 200 of FIG. 2. Hash table 300 includes 4 by 5 hash bins that use four different hash functions (one for each hash bin). Each of the hash bins 310, 320, 330, and 340 has five entries per row and each entry can hold up to four key-value pairs. As an example, hash bin 310 uses hash function A, hash bin 320 uses hash function B, hash bin 330 uses hash function C, and hash bin 340 uses hash function C. Each of the hash bins has a depth of N rows. Depending upon the depth of hash bins, the CRC polynomial is chosen. Each hash function uses an incoming key value and a different static integer (e.g., random number A, random number B, random number C, or random number D) along with the incoming key value to compute the hash. The computed hash indexes into a respective hash bin. As noted earlier, each entry in the hash table can hold up to four key-value pairs. An entry is marked as available or as used. Once the hash values are computed and the corresponding hash table entries (e.g., 4×5=20) are read, before performing an operation, the incoming key-value pair is compared with the key values in all of the used bins to determine if the key-value pair is already stored in the hash table. In case of a match the value part of the hash entry should contain further information related to the entry. If there is no match, then the new key-value pair is stored in one of the available entries starting from left to right.

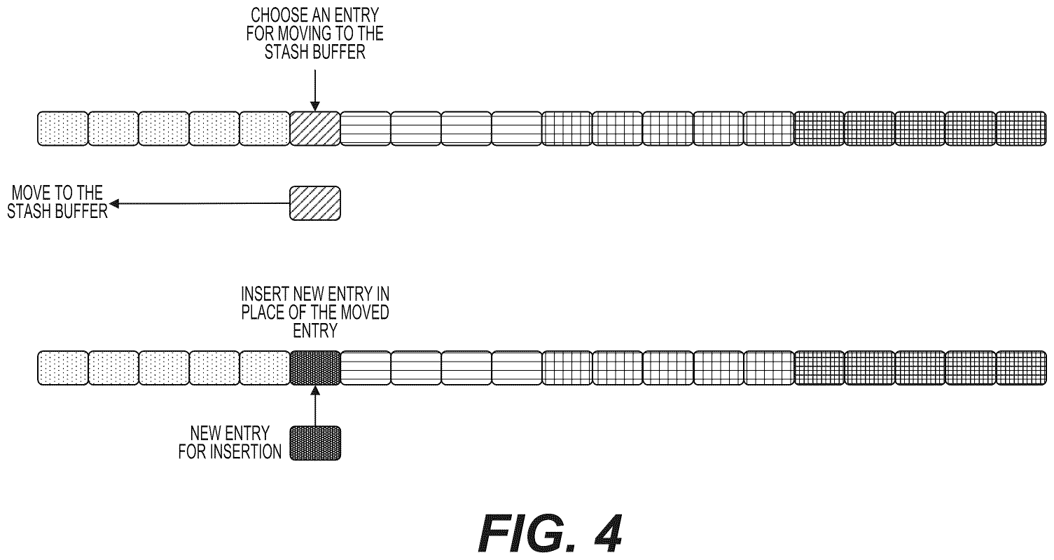

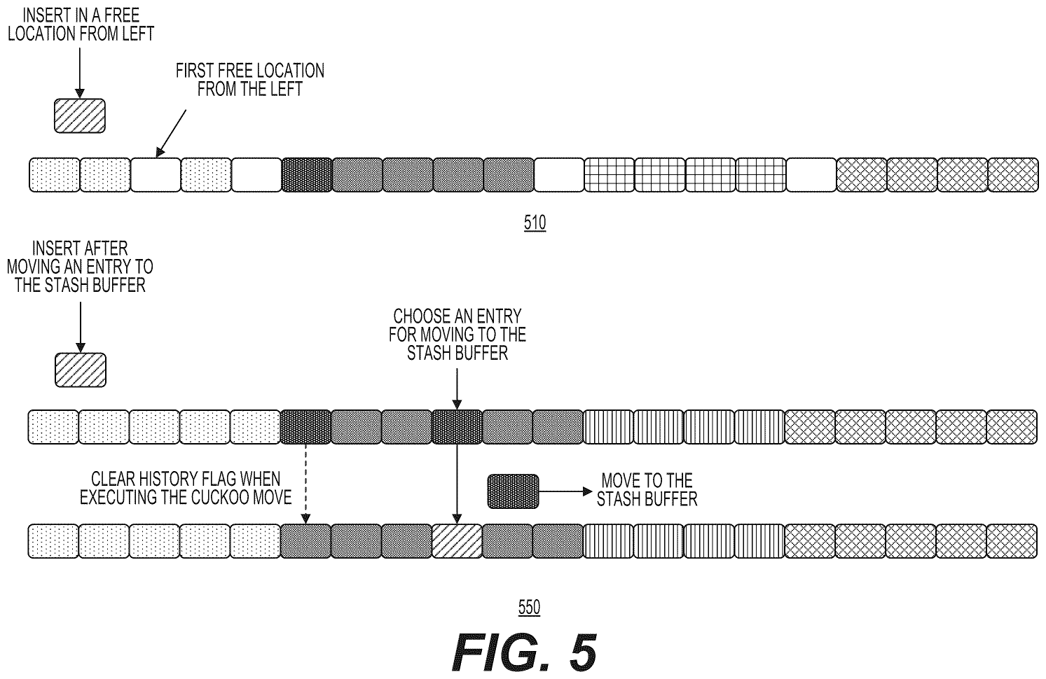

If all twenty entries in a hash bin (e.g., hash bin 310) are used, then as shown in FIG. 4, an entry is selected for move to the stash buffer (e.g., stash buffer 210 of FIG. 2). As shown further in FIG. 4, in place of the moved entry, the new entry is inserted. The new entry is marked with a history flag to avoid being pushed out again when executing a cuckoo move (described further with respect to FIG. 5). Once an entry is moved to the stash buffer, to bring it back into a hash table, a move called the cuckoo move is performed. As part of the cuckoo move, if empty slots are found in the hash table, then the entry can be inserted into the hash table and can also be deleted from the stash buffer. The entry that is recently moved to the stash buffer has one of the four hash function values common with the incoming key hash function value. However, because there are three other different hash function values, there are nineteen possible homes when one tries to reinsert the vacated entry from the stash buffer into the hash table. This process of reinserting the vacated entry from the stash buffer into the hash table is called a cuckoo move. As shown by example 510 of FIG. 5, as part of the cuckoo move, the entry is inserted into the first free location from the left. If the hash table is full, however, then as shown by example 550, first an entry is chosen for being moved to the stash buffer to make place for the entry. The moved entry is placed in the stash buffer, and the cuckoo move is attempted again. The history flag set earlier will prevent the moving out of the original entry thereby avoiding an unnecessary cuckoo move cycle. All history flags are cleared when the cuckoo move is performed. The process is repeated until the evicted entry from the hash table finds a home back in the hash table via a series of cuckoo moves.

With the example of hash table 300, having four different hash functions and 5-ways, the efficiency of the hash table loading is approximately within a range of 90-95%. With a 25% larger hash table capacity than the size of the cache data RAM, one can almost guarantee a hundred percent loading for the cache data RAM. As an example, with a 5 K deep hash table having four hash functions and 5-ways and a 4 K cache, one could have guaranteed hundred percent loading for the cache. The loading of the cache can be further guaranteed by combining this hash table structure with an LRU-based eviction from the cache to provide space for the incoming new cache insert requests (enhanced by using the stash buffer and the cuckoo moves). Broadly speaking, for a given target latency, the hardware cache macro needs to absorb all incoming requests without applying a back pressure to the request interface due to the hash table loading issues. In one example, a minimum stash buffer depth of 256 could guarantee that all incoming requests can be absorbed for a given performance target. As explained later, using various performance analysis tools and design code, one can achieve a scalable hardware cache for use with hardware accelerators that can satisfy various latency requirements.

As explained earlier, the HCM 200 implements a least recently used (LRU)-based cache eviction policy, which removes the least recently used entry from the cache (e.g., cache data RAM 208 of FIG. 2) when the cache is full. In one example, the LRU-based policy is implemented by maintaining a queue of the cache entries using a doubly-linked list. The maximum size of the queue is selected to be equal to the total number of entries that can be stored in the cache. The new entries are inserted at the head of the queue and the entries are retired from the tail of the queue. The linked list contains both forward and backward pointers. FIG. 6 shows an example queue 610 and an example of link updates 630 to the queue. For the example queue 610, the links between adjacent previous pointers or the next pointers are implicit and are not shown. The head pointer points to a previous entry in the linked list whereas the tail pointer points to the next entry in the linked list.

In terms of the operation of the LRU-based eviction policy, each time a cache entry is accessed (read from or written to), the entry is removed from an arbitrary place in the linked list and re-inserted at the head of the queue. When the cache is full, the entry from the tail of the queue is removed and evicted from the cache, making space for any newly arriving entry. As a result, the most recently used entries will be near the head of the queue whereas the least recently used entries will be near the tail of the queue. Register values controlled via software can be used to control the number of entries being held in the cache. In addition, register values (e.g., control and status register (CSR) values) can also be used to specify the cache occupancy level at which evictions should start occurring.

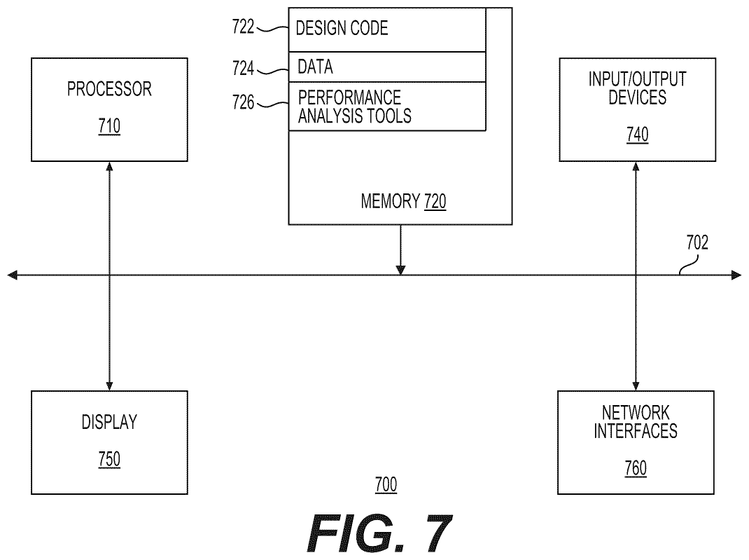

FIG. 7 is a block diagram of a computing system 700 for addressing latency issues with a hardware cache integrated within a hardware accelerator. Computing system 700 includes a processor 710, a memory 720, input/output devices 740, display 750, and network interfaces 760 interconnected via a bus system 702. Memory 720 may include design code 722, data 724 (including simulated data and real data associated with the hardware cache macro), and performance and analysis tools 726.

Design code 722 may include program instructions that, when executed by processor 710, allow computing system 700 to enable various aspects of the performance of the methods described herein. In addition, design code 722 may include libraries or other code for allowing processor 710 to display relevant information (e.g., graphs or plots) on display 750. Design code 722 may also allow input/output devices 740 to receive or transmit information associated with the methods described herein. Data 724 includes simulations-based data or measurement data. Data 724 may further include performance data, including expected latency values.

Performance and analysis tools 726 may include instructions for executing steps described with respect to the various methods described herein. As an example, performance and analysis tools 726 may include instructions allowing one to vary the various hardware cache parameters and evaluate the expected read/write memory latency values. As another example, performance and analysis tools 726 may allow one to evaluate the LRU eviction policy in view of the different values for the sizes of the cache data RAM, the hash table, and the stash buffer described earlier. Although FIG. 7 shows a certain number of components of computing system 700 arranged in a certain way, additional or fewer components arranged differently may also be used. In addition, although memory 720 shows certain blocks of code and data, the functionality provided by this code and data may be combined or distributed. In addition, the various blocks of code and data may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media.

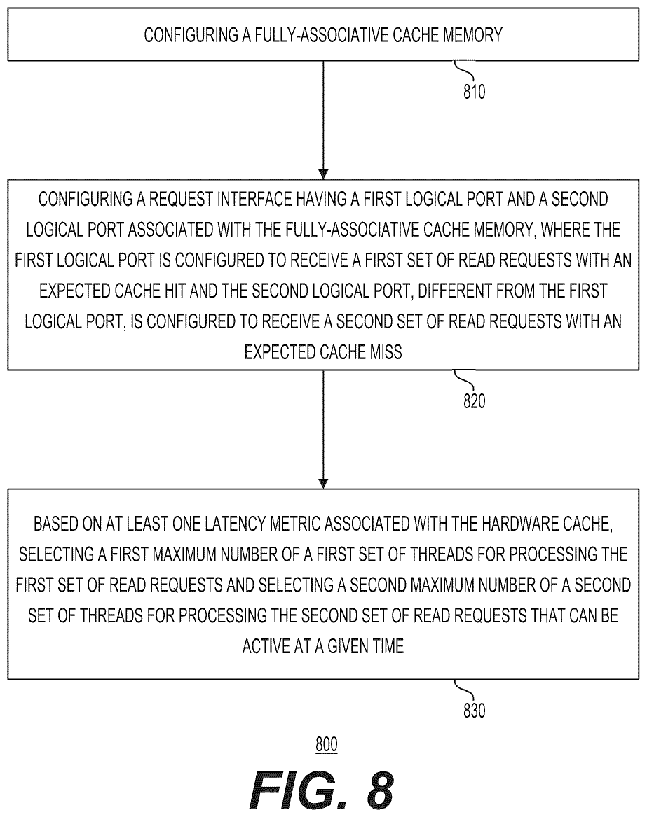

FIG. 8 shows a flow chart 800 of an example method for addressing latency issues with a hardware cache integrated within a hardware accelerator. In one example, the steps associated with this method can be performed using the computing system 700 of FIG. 7. As an example, instructions for each of the steps of this method can be stored in memory 720 of FIG. 7. These instructions, when executed by processor 710 of FIG. 7, can perform these steps in conjunction with the code and data stored in memory 710, which is described earlier. Step 810 includes configuring a fully-associative cache memory. This step includes selecting a size for the cache data RAM and at least some of the other parameters described earlier with respect to table 3.

Step 820 includes configuring a request interface having a first logical port and a second logical port associated with the fully-associative cache memory, where the first logical port is configured to receive a first set of read requests with an expected cache hit and the second logical port, different from the first logical port, is configured to receive a second set of read requests with an expected cache miss. This step includes configuring the request interface (e.g., request interface 202 of HCM 200 of FIG. 2). As explained earlier, the request interface 202 of FIG. 2 can support multiple logical ports with separate sets of credits for each of the logical ports and associated first-in first-out buffers (FIFOs). As an example, request interface can support four logical ports with separate sets of credits for each of the four logical ports and associated first-in first-out buffers (FIFOs). The FIFOs can be implemented as physical memory that holds all of the descriptors. Moreover, as explained earlier, with respect to table 4 and the related description, different logical ports can be configured to handle read requests that are expecting a cache hit versus those read requests that are expecting a cache miss. Advantageously, by having different logical ports handle these different requests, one can allocate a different number of threads for handling these requests. This allows one to configure the hardware cache in a scalable manner that takes the expected latency into account.

Step 830 includes based on at least one latency metric associated with the hardware cache, selecting a first maximum number of a first set of threads for processing the first set of read requests and selecting a second maximum number of a second set of threads for processing the second set of read requests that can be active at a given time. As explained earlier, the latency metric can be the expected read latency or the expected write latency. Moreover, tables 6 and 7 provide an example of selecting an allocation of the threads in the thread database based on the latency metrics.

In conclusion, the present disclosure relates to a scalable hardware cache including a fully-associative cache memory. The scalable hardware cache may further include a request interface having a first logical port and a second logical port associated with the fully-associative cache memory. The first logical port may be configured to receive a first set of read requests with an expected cache hit and the second logical port, different from the first logical port, may be configured to receive a second set of read requests with an expected cache miss.

The scalable hardware cache may further include thread processing circuitry configured to manage a first set of threads for processing the first set of read requests and a second set of threads for processing the second set of read requests, where each of a first maximum number of the first set of threads and a second maximum number of the second set of threads that can be active at a given time is selected based on a performance metric associated with the scalable hardware cache.

The scalable hardware cache may further comprise a thread database manager for tracking each of the first set of threads and the second set of threads. The scalable hardware cache may further comprise a least-recently used (LRU)-eviction policy manager for the fully-associative cache memory.

The fully-associative cache may comprise a cache data random access memory (RAM), a hash table, and a stash buffer. The stash buffer may be configured to store cache entries moved out of the hash table. The hash table may comprise a plurality of bins. The hash table may be accessed via a computed hash index that is generated using an incoming key value, a different static integer for each one of the plurality of bins of the hash table, and a different hash function for each one of the plurality of bins of the hash table. A size of the hash table and a size of the stash buffer relative to the cache data RAM may be selected to allow for a full loading of the cache data RAM.

In another example, the present disclosure relates to a scalable hardware cache including a fully-associative cache memory. The scalable hardware cache may further include a request interface having a first logical port and a second logical port associated with the fully-associative cache memory, where the first logical port is configured to receive a first set of read requests with an expected cache hit and the second logical port, different from the first logical port, is configured to receive a second set of read requests with an expected cache miss.

The scalable hardware cache may further include thread processing scheduler circuitry configured to receive the first set of read requests and the second set of read requests and schedule the first set of read requests for processing using a first set of threads and schedule the second set of read requests for processing using a second set of threads. The scalable hardware cache may further include thread processing circuitry configured to, based on at least one latency metric associated with the hardware cache, select a first maximum number of the first set of threads for processing the first set of read requests and select a second maximum number of the second set of threads for processing the second set of read requests that can be active at a given time.

The scalable hardware cache may further comprise a thread database manager for tracking each of the first set of threads and the second set of threads. The scalable hardware cache may further comprise a least-recently used (LRU)-eviction policy manager for the fully-associative cache memory.

The fully-associative cache may comprise a cache data random access memory (RAM), a hash table, and a stash buffer. The stash buffer may be configured to store cache entries moved out of the hash table. The hash table may comprise a plurality of bins. The hash table may be accessed via a computed hash index that is generated using an incoming key value, a different static integer for each one of the plurality of bins of the hash table, and a different hash function for each one of the plurality of bins of the hash table. A size of the hash table and a size of the stash buffer relative to the cache data RAM may be selected to allow for a full loading of the cache data RAM.

In yet another example, the present disclosure relates to a method for addressing latency issues with a hardware cache integrated within a hardware accelerator. The method may include configuring a fully-associative cache memory. The method may further include configuring a request interface having a first logical port and a second logical port associated with the fully-associative cache memory, where the first logical port is configured to receive a first set of read requests with an expected cache hit and the second logical port, different from the first logical port, is configured to receive a second set of read requests with an expected cache miss.

The method may further include based on at least one latency metric associated with the hardware cache, selecting a first maximum number of a first set of threads for processing the first set of read requests and selecting a second maximum number of a second set of threads for processing the second set of read requests that can be active at a given time.

The fully-associative cache may comprise a cache data random access memory (RAM), a hash table, and a stash buffer. The method may further include selecting a size of the hash table and a size of the stash buffer relative to the cache data RAM to allow for a full loading of the cache data memory.

In one example, the at least one latency metric comprises an expected read latency. In another example, the at least one latency metric comprises an expected write latency. The method may further include selecting an organization of a thread database and an allocation of thread entries within the thread database for logical ports associated with the fully-associative cache memory.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), and Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A scalable hardware cache comprising:
a fully-associative cache memory;
a request interface having a first logical port and a second logical port associated with the fully-associative cache memory, wherein the first logical port is to receive a first set of read requests with an expected cache hit and the second logical port, different from the first logical port, is to receive a second set of read requests with an expected cache miss; and
thread processing circuitry to manage a first set of threads for processing the first set of read requests and a second set of threads for processing the second set of read requests, wherein each of a first maximum number of the first set of threads and a second maximum number of the second set of threads that can be active at a given time is selected based on a performance metric associated with the scalable hardware cache.

2. The scalable hardware cache of claim 1, further comprising a thread database manager for tracking each of the first set of threads and the second set of threads.

3. The scalable hardware cache of claim 1, further comprising a least-recently used (LRU)-eviction policy manager for the fully-associative cache memory.

4. The scalable hardware cache of claim 1, wherein the fully-associative cache comprises a cache data random access memory (RAM), a hash table, and a stash buffer.

5. The scalable hardware cache of claim 4, wherein the stash buffer is configured to store cache entries moved out of the hash table.

6. The scalable hardware cache of claim 4, wherein the hash table comprises a plurality of bins, and wherein the hash table is accessed via a computed hash index that is generated using an incoming key value, a different static integer for each one of the plurality of bins of the hash table, and a different hash function for each one of the plurality of bins of the hash table.

7. The scalable hardware cache of claim 4, wherein a size of the hash table and a size of the stash buffer relative to the cache data RAM is selected to allow for a full loading of the cache data RAM.

8. A scalable hardware cache comprising:
a fully-associative cache memory;
a request interface having a first logical port and a second logical port associated with the fully-associative cache memory, wherein the first logical port is to receive a first set of read requests with an expected cache hit and the second logical port, different from the first logical port, is to receive a second set of read requests with an expected cache miss;
thread processing scheduler circuitry to receive the first set of read requests and the second set of read requests and schedule the first set of read requests for processing using a first set of threads and schedule the second set of read requests for processing using a second set of threads; and
thread processing circuitry to, based on at least one latency metric associated with the hardware cache, select a first maximum number of the first set of threads for processing the first set of read requests and select a second maximum number of the second set of threads for processing the second set of read requests that can be active at a given time.

9. The scalable hardware cache of claim 8, further comprising a thread database manager for tracking each of the first set of threads and the second set of threads.

10. The scalable hardware cache of claim 8, further comprising a least-recently used (LRU)-eviction policy manager for the fully-associative cache memory.

11. The scalable hardware cache of claim 8, wherein the fully-associative cache comprises a cache data random access memory (RAM), a hash table, and a stash buffer.

12. The scalable hardware cache of claim 11, wherein the stash buffer is configured to store cache entries moved out of the hash table.

13. The scalable hardware cache of claim 11, wherein the hash table comprises a plurality of bins, and wherein the hash table is accessed via a computed hash index that is generated using an incoming key value, a different static integer for each one of the plurality of bins of the hash table, and a different hash function for each one of the plurality of bins of the hash table.

14. The scalable hardware cache of claim 11, wherein a size of the hash table and a size of the stash buffer relative to the cache data RAM is selected to allow for a full loading of the cache data RAM.

15. A method for addressing latency issues with a hardware cache integrated within a hardware accelerator, the method comprising:
configuring a fully-associative cache memory;
configuring a request interface having a first logical port and a second logical port associated with the fully-associative cache memory, wherein the first logical port is configured to receive a first set of read requests with an expected cache hit and the second logical port, different from the first logical port, is configured to receive a second set of read requests with an expected cache miss; and
based on at least one latency metric associated with the hardware cache, selecting a first maximum number of a first set of threads for processing the first set of read requests and selecting a second maximum number of a second set of threads for processing the second set of read requests that can be active at a given time.

16. The method of claim 15, wherein the fully-associative cache comprises a cache data random access memory (RAM), a hash table, and a stash buffer.

17. The method of claim 16, further comprising selecting a size of the hash table and a size of the stash buffer relative to the cache data RAM to allow for a full loading of the cache data memory.

18. The method of claim 15, wherein the at least one latency metric comprises an expected read latency.

19. The method of claim 15, wherein the at least one latency metric comprises an expected write latency.

20. The method of claim 15, further comprising selecting an organization of a thread database and an allocation of thread entries within the thread database for logical ports associated with the fully-associative cache memory.
